(19) United States
(12) Patent Application Publication
(10) Pub. No.: US 2002/0022454 A1
(43) Pub. Date: Feb. 21, 2002

(54) Contactless integrated circuit with reduced power consumption

(76) Inventors: Didier Serra, Septeme les Vallons (FR); Nicolas Pangaud, Aix en Provence (FR); Michel Martin, Rognes (FR); Francois Bergouignan, Aix en Provence (FR)

Correspondence Address: James E. Nilles, Nilles & Nilles, S.C., Firstar Center, Suite 2000, 777 East Wisconsin Avenue, Milwaukee, WI, 53202, US

(21) Appl. No.: 09/840,244

(22) Filed: Apr. 23, 2001

Related U.S. Application Data
(63) Continuation of application No. PCT/FR99/02569, filed on Oct. 22, 1999.

(30) Foreign Application Priority Data
Oct. 23, 1998 (FR) 98 13470

(51) Int. Cl. H04B 5/00

(52) U.S. Cl. 455/41; 235/435

(57) ABSTRACT

An integrated circuit with contactless functioning including devices for modulating the load of the an antenna coil, extracting a clock signal, and delivering a pulsed load modulating signal comprising a series of load modulating pulses with duration asynchronously calibrated by the charge or discharge of a capacitor and for inhibiting the clock extraction device at least while load modulating pulses are being emitted. The invention permits the reduction of the integrated circuit power consumption during data transmission intervals.

The present invention relates to contactless integrated circuits using electromagnetic induction, of the type used in contactless chip cards, electronic labels, electronic tags.

The present invention relates more particularly to a contactless integrated circuit comprising a modulation device of the load of an antenna coil, a clock extraction device and means for delivering a load modulation signal according to a binary signal to be transmitted.

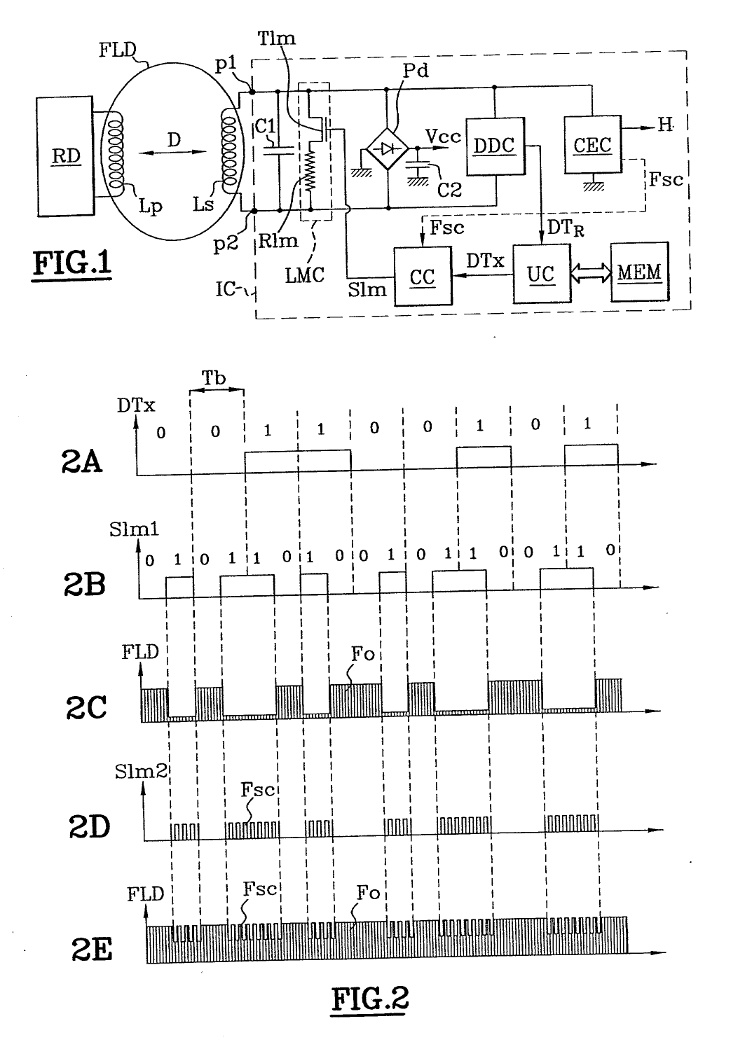

FIG. 1 schematically shows the architecture of a contactless integrated circuit IC, connected to an antenna coil Ls by means of contact pins p1, p2. Coil Ls forms, with an integrated capacitor C1, a resonant circuit having an own frequency Fo. Circuit IC is arranged close to a data emitting-receiving station RD, for example a chip card reader, provided with a primary coil Lp. The whole device forms a bi-directional data transmission system by inductive coupling.

Circuit IC comprises a central processing unit UC, an EEPROM-type non volatile memory MEM, a rectifier bridge Pd followed by a smoothing capacitor C2, and a clock extraction circuit CEC. In presence of an alternating magnetic field FLD of frequency Fo emitted by the primary coil Lp, an a.c. induced voltage Vac appears at the terminals of coil Ls. Rectifier Pd extracts a d.c. voltage Vcc from voltage Vac, providing the voltage supply of circuit IC, and circuit CEC extracts from voltage Vac a clock signal H, the frequency of which is a sub-multiple of carrier Fo. Station RD also extracts its own clock signal from frequency Fo, so that circuit IC and station RD are synchronized.

In such a system, the transmission of data DT_{R} to integrated circuit IC is generally performed by modulating the amplitude of magnetic field FLD, circuit IC comprising to that effect a circuit DCC for demodulating the induced voltage Vac, decoding the modulation signal and delivering the received data DT_{R} to central processing unit UC.

In the following, there will be more particularly dealt with the transmission of data DTx to station RD using load modulation. Such a load modulation is generally obtained by means of a modulator circuit LMC connected to the terminals of coil Ls, and comprising for example a switch Tlm and a resistance Rlm arranged in series. Data DTx to be transmitted are applied to a coder circuit CC, the output of which delivers a coded modulation signal Slm applied to modulator circuit LMC. The latter short-circuits coil Ls according to signal Slm and the load modulation passes by inductive coupling on primary coil Lp. Opposite demodulation and decoding operations enable station RD to receive data DTx.

As a prior art example regarding load modulation, U.S. Pat. No. 4,681,111 describes, in relation with its FIGS. 1 and 2, an integrated circuit using a BPSK coded load modulation signal (phase shifted). This patent also describes, in relation with its FIGS. 13, 14, a data transmission technique which does not belong to the context of the present application, according to which an antenna circuit is energized by a d.c. voltage by means of a switch. The switch is driven by a coded signal constituted by variable width pulses, and its closing causes the presence, in the antenna circuit, of an oscillation which passes on the coil of the data receiving station.

Furthermore, it is known that load modulation may be performed by means of a binary modulation signal Slm combined with a sub-carrier Fsc extracted from carrier Fo, as described in U.S. Pat. No. 4,857,893, as well as in U.S. Pat. No. 5,345,231 or its equivalent EP 0473569. It should be noted that the load modulation described in the U.S. Pat. No. 4,857,893 consists in injecting the sub-carrier into a branch of a rectifier bridge by means of a logic gate. The injection of a “0” leads to a partial short-circuit of a branch of the rectifier bridge, that is a load modulation equivalent to the one which is obtained by means of a switch arranged in parallel with the antenna coil.

It is generally admitted that such a load modulation is more advantageous than a binary load modulation due to a better signal/noise ratio at reception, allowing the choice a smaller modulation depth, for example in the order of 30% compared to 50 to 70% with a binary load modulation, improving the transfer of energy to circuit IC during the load modulation periods.

However, in practice, the load modulation periods cause a substantial attenuation of the energy transmitted to integrated circuit IC, even when a sub-carrier is used. This attenuates the induced voltage Vac and the voltage supply Vcc, and consequently decreases the maximal communication distance D with circuit IC, beyond which circuit IC stops working.

This problem is in practice added to a consumption problem of integrated circuit IC, appearing in high frequency applications, for example when carrier Fo has a standard value of 13,56 MHz. Integrated circuit IC being generally a CMOS technology integrated circuit, its consumption depends on the switching speed of the transistors which constitute the circuit. In particular, clock extraction circuit CEC, which is driven by carrier Fo, can consume on its own a current in the order of 10 μA with a voltage Vcc of 2V, for a total consumption of the integrated circuit in the order of 20 μA. Such a consumption must be compensated by a stronger inductive coupling between station RD and circuit IC, involving again a decrease of the maximal communication distance.

Thus, an object of the present invention is to provide a load modulation method disturbing less the magnetic field and enabling a better transmission of energy to a contactless integrated circuit.

Another object of the present invention is to decrease the consumption of a contactless integrated circuit during the load modulation periods.

To achieve these objects, the present invention provides a contactless integrated circuit of the type defined here-above, comprising means for delivering a pulsed load modulation signal comprising a series of load modulation pulses, the duration of which is asynchronously calibrated by the charge or the discharge of at least one capacitor.

Advantageously, the integrated circuit comprises means for inhibiting the clock extraction device at least during the emission of the load modulation pulses.

According to an embodiment, the means for delivering the pulsed load modulation signal comprise at least two capacitors and means for charging the first capacitor with a constant current before the emission of a load modulation pulse, during a time fixed by a predetermined number of clock cycles, charging the second capacitor with a constant current during the emission of a pulse, and stopping the emission of the pulse when the charge voltage of the second capacitor is equal to the voltage at the terminals of the first capacitor.

According to an embodiment, the integrated circuit comprises means for transforming the binary signal to be transmitted into a binary coded signal presenting at least, at each bit of the binary signal, a rising or falling variation edge, and transforming variation edges of the binary coded signal into load modulation pulses of short duration compared to the duration of a bit of the binary signal to be transmitted.

According to an embodiment, variation edges of a same type only, rising or falling, of the binary coded signal are transformed into load modulation pulses by the means for delivering the modulation signal.

According to an embodiment, the pulsed load modulation signal is combined with an a.c. signal in order to form a load modulation signal comprising a.c. signal pulses.

Preferably, the load modulation pulses have a duration shorter than or equal to the quarter of the duration of a bit of the binary signal to be transmitted.

According to an embodiment, the clock extraction device is maintained in an inhibited state after the emission of a load modulation pulse at least for a time equal to the duration of a load modulation pulse.

According to an embodiment, the clock extraction device is arranged to extract a clock signal from an a.c. voltage induced in the antenna coil.

According to an embodiment, the integrated circuit comprises means for extracting a d.c. supply voltage from an a.c. voltage induced in the antenna coil.

According to an embodiment, the means for inhibiting the clock extraction device comprise means for powering-off the extraction device.

These objects, characteristics and advantages, as well as others of the present invention will be exposed with more details in the following description of a load modulation method according to the invention, a load modulation device according to the invention and an integrated circuit comprising such a device, in conjunction with the accompanying drawings in which:

FIG. 1, previously described, shows in block form the conventional architecture of a contactless integrated circuit,

FIGS. 2A to 2E are timing diagrams of electric signals illustrating two conventional load modulation methods,

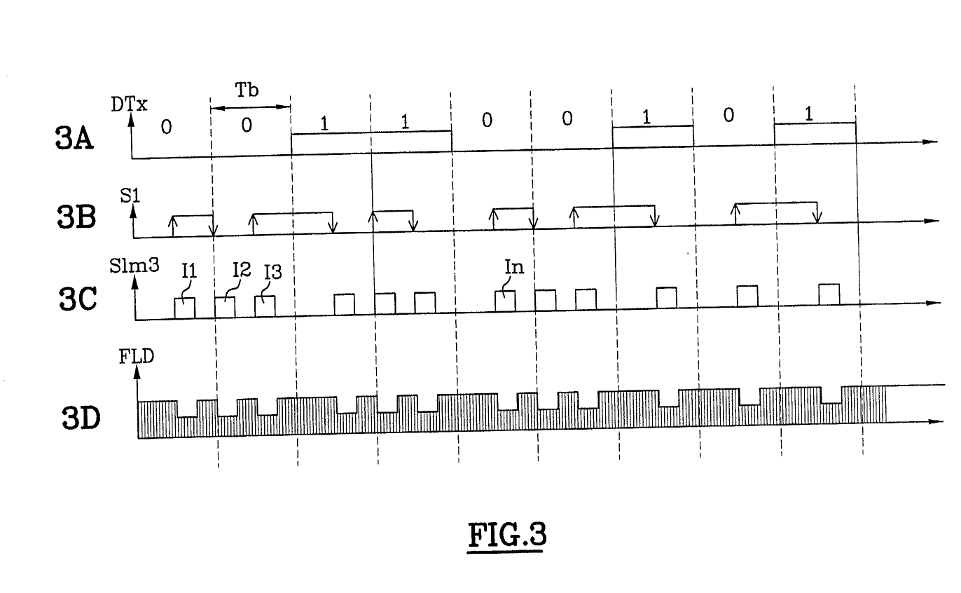

FIGS. 3A to 3D are timing diagrams of electric signals illustrating the general principle of the load modulation method according to the invention,

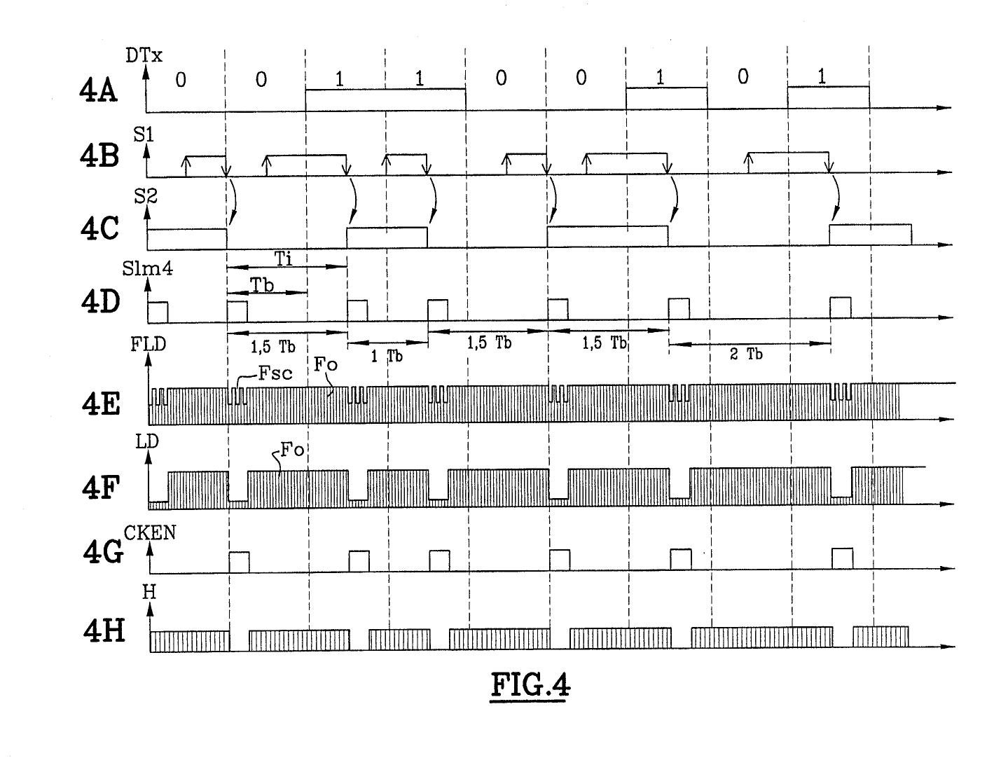

FIGS. 4A to 4H are timing diagrams of electric signals illustrating a preferred embodiment of the method according to the invention,

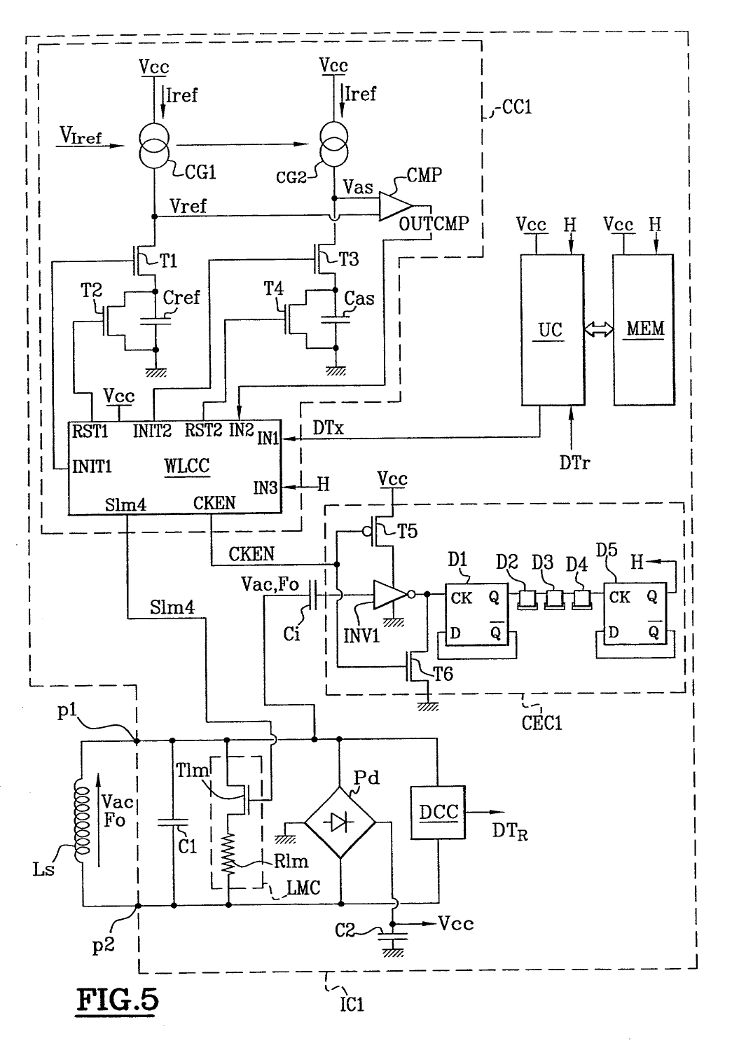

FIG. 5 is the electrical diagram of a contactless integrated circuit comprising a load modulation device of FIG. 5,

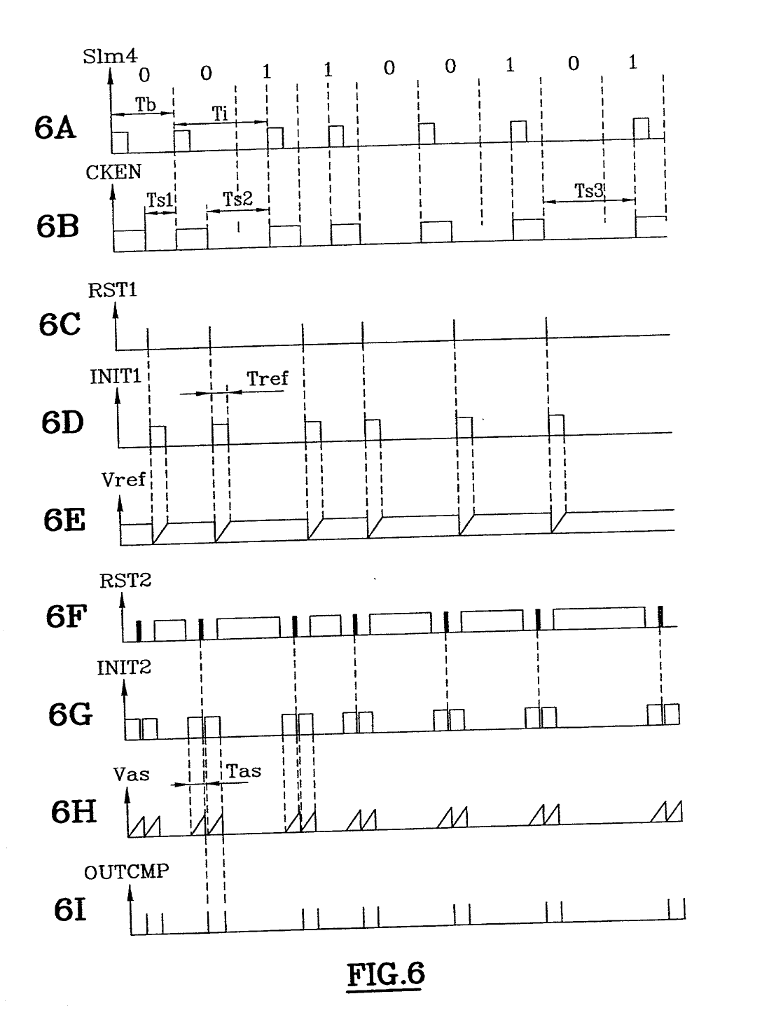

FIGS. 6A to 6I are timing diagrams of various electric signals appearing in the load modulation device according to the invention, and

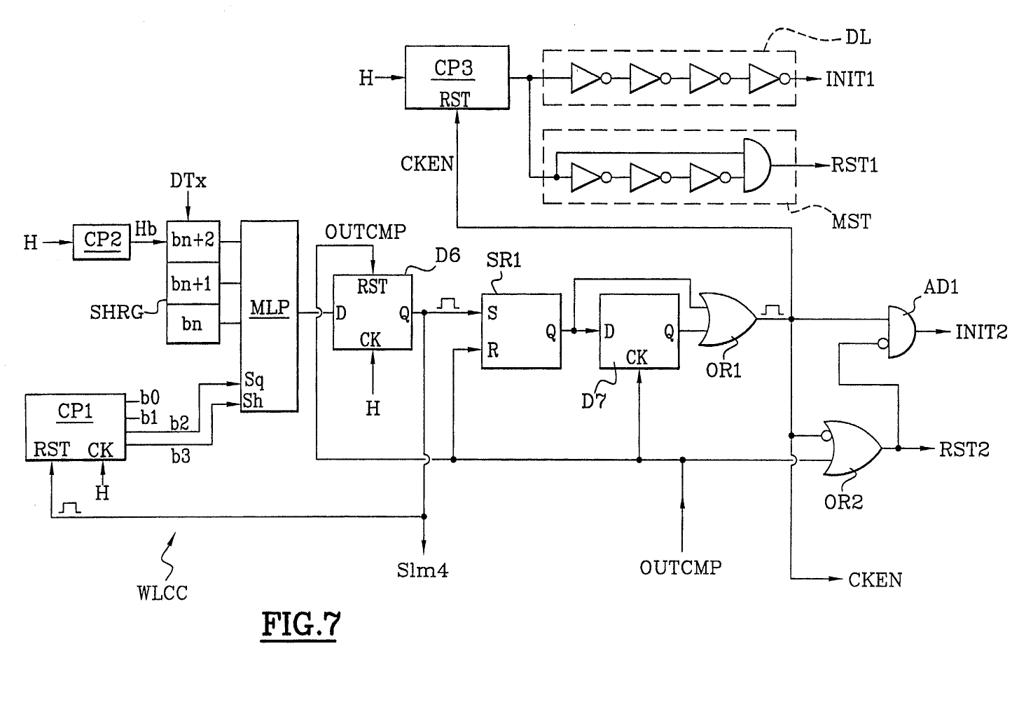

FIG. 7 is the electrical diagram of a logic circuit represented in block form in FIG. 5.

### SUMMARY RELATING TO PRIOR ART

FIGS. 2A to 2C illustrate the conventional binary load modulation technique mentioned in the preamble. FIG. 2A shows the signal to be transmitted DTx, FIG. 2B shows a binary load modulation signal Slm1 derived from signal DTx, and FIG. 2C shows the envelope of magnetic field FLD during the transmission of signal DTx. Signal Slm1 is here obtained by Manchester coding signal DTx, so that a bit at “0” of signal DTx is coded by the bit series “01” and a bit at “1” is coded by the bit series “10”. When signal Slm1 is at 1, magnetic field FLD presents a clear and constant amplitude attenuation due to magnetic short-circuit. A falling modulation edge in the middle of binary period Tb corresponds to the transmission of a “1” and a rising modulation edge corresponds to the transmission of a “0”.

FIG. 2E shows the envelope of magnetic field FLD when load modulation is performed by means of a sub-carrier Fsc extracted from carrier Fo, for example by means of circuit CEC shown in FIG. 1. Signal Slm1 of FIG. 2B is combined with sub-carrier Fsc for forming modulation signal Slm2 represented in FIG. 2D. In this case, a modulation period followed by an idle period corresponds to the transmission of a “1” and an idle period followed by a modulation period corresponds to the transmission of a “0”, according to the Manchester coding of signal Slm1.

Whatever the chosen method may be, the modulation periods represent at least 50% of the time required for transferring data DTx. As explained in the preamble, the load modulation limits the energy transmited by induction and decreases the maximal communication distance with a contactless integrated circuit.

First Aspect of the Invention: Decrease of the Duration of the Load Modulation Periods

According to a first aspect of the invention, there is provided the transformation of the variation edges of a conventional load modulation signal into modulation pulses, so that a load modulation signal according to the invention is a pulsed signal, constituted by load modulation pulses. By choosing modulation pulses with a small width and a coding providing a small recurrence of the pulses, the duration of the modulation periods is significantly reduced and the transfer of energy by induction is improved.

By way of example, FIG. 3A shows a signal DTx to be transmitted by load modulation, identical to the signal of FIG. 2A. FIG. 3B shows a coded signal S1 obtained by Manchester coding signal DTx, identical to signal Slm1 of FIG. 2B, and FIG. 3D shows the envelope of magnetic field FLD. Here, signal S1 is not used as a modulation signal but is transformed into a series of pulses I1, I2, I3 . . . In forming a modulation signal Slm3 according to the invention. The duration of the pulses is here chosen equal to or shorter than a quarter of the binary period Tb and the load modulation periods statistically represent less than 50% of the transfer time of signal DTx, as this appears in FIG. 3D.

FIGS. 4A to 4D illustrate a preferred embodiment of the method according to the invention, where the recurrence of the load modulation pulses, that is the average number of pulses by time unit, is decreased compared to the previous example. FIGS. 4A and 4B are identical to FIGS. 3A and 3B and show the signal to be transmitted DTx and the Manchester coded signal S1. Here, the variation edges of signal S1 of a same type only, here the falling edges, are transformed into load modulation pulses, in order to form the modulation signal Slm4 represented in FIG. 4D. In practice, the transformation of signal S1 into signal Slm4 may be obtained by an intermediate step of transforming signal S1 into a Miller coded signal S2 presenting a rising or falling edge at each edge of a same type of signal S1, here the falling edge. Then, each rising and falling edge of signal S2 is transformed into a load modulation pulse I1, I2, I3 . . . In, the duration of which is here chosen equal to the quarter of the binary period Tb of signal DTx.

The coding of signal Slm4 being known per se with the denomination of pulsed Miller coding, it should be noted that the present invention has not the objet of a new coding technique but rather consists in an application of a known coding technique to the field of load modulation in order to decrease the average load modulation time and to obtain a better transmission of energy by induction during the load modulation periods. Experiments made by the applicant have shown that such modulation pulses are easily detectable by a emitting-receiving station of the type represented in FIG. 1, provided with a conventional demodulation circuit, and provide in particular short and clear current pulses in primary coil Lp.

Once the modulation pulses have been detected, the decoding of signal Slm4 for retrieving the bits of signal DTx require a mere counting of the duration Ti which separates two pulses. To aid in better understanding, table 1 here-after illustrates the decoding algorithm of signal Slm4, and gives the value of the bit or the following bits according to the value of the bit or the previous bits and the duration Ti between two pulses. The bit or the previous bits being known, the value of the following bit or the couple of following bits is directly derived from duration Ti. In order to initialize the algorithm, it is convenient to insert, into signal DTx, a binary sequence chosen by convention, known by the device providing the decoding. This sequence may be for example a series of “1” (only one “1” being sufficient) or a series of “0” (a couple of zeros “00” being sufficient). Furthermore, the values mentioned in the table must be inverted if it is chosen to transform the rising edges of signal S1 into modulation pulses.

TABLE 1
Following bit(s) = Function (Ti, previous bit(s))

| Previous bit(s) → | | |
|---|---|---|
| Duration Ti ↓ | 1 | 00 |
| Tb | 1 | 0 |
| 1,5 Tb | 00 | 1 |
| 2 Tb | 01 | — |

Thus, the present invention provides a significant decrease of the load modulation periods, a load modulation pulse allowing the coding of one or two bits according to the sequence order of the bits. Statistically, the load modulation periods represent 12,5% of the transfer time of signal DTx when this signal is composed of an alternance of “0” and “1”, and 25% of the transfer time when the signal DTx comprises a series of “1” or a series of “0”, for a pulse width equal to the quarter of the binary period Tb of signal DTx. The average load modulation duration with any signal DTx is situated between these two extremes.

Of course, the term “modulation pulse” must not be interpreted as only meaning that a load modulation according to the invention is a binary modulation. In practice, the load modulation pulses may be combined with a sub-carrier Fsc in order to produce sub-carrier pulses. The aspect of the magnetic field FLD modulated by such pulses of sub-carrier Fsc is represented in FIG. 4E. In this case, the load modulation pulses only define modulation windows. In addition, the aspect of the magnetic field FLD directly modulated by signal Slm4 is represented in FIG. 4F.

Second Aspect of the Invention: Decrease of the Electric Consumption During Load Modulation

Another aspect of the invention will be now described, aiming at the decrease of the electric consumption of a contactless integrated circuit during the periods of load modulation. As indicated in the preamble, the consumption of a contactless integrated circuit is not negligible with a H.F. carrier, the clock extraction circuit being capable to consume on its own about 25% to 50% of the current supplied to the integrated circuit.

Here the idea of the present invention is to calibrate the duration of the load modulation pulses by means of an analog asynchronous circuit of a type which charges or discharges a capacitor, and stops the clock extraction circuit during the emission periods of the pulses. To aid in better understanding, FIG. 4G shows a clock inhibition signal CKEN according to the invention and FIG. 4H shows the clock signal H extracted from carrier Fo. Signal CKEN is set to 1 during the emission of the load modulation pulses, and the clock signal H is interrupted during these periods. An integrated circuit operating in this way has an asynchronous operating period during the emission of load modulation pulses, during which its electric consumption is practically equal to zero, and a synchronous operating period between the end of the pulse and the beginning of the following pulse.

This aspect of the invention is implemented by means of a coder circuit CC1, represented in FIG. 5 within a contactless integrated circuit IC1. Integrated circuit IC1 is similar to circuit IC of FIG. 1 except for the coder circuit CC1, which replaces the conventional circuit CC, and a clock extraction circuit CEC1 replacing the conventional circuit CEC. The other elements of circuit IC1 are designated by the same references as in FIG. 1.

Coder circuit CC1 comprises a wired logic sequential circuit WLCC, a capacitor Cref, a capacitor Cas, various switches T1, T2, T3, T4 having the form of NMOS transistors, a comparator CMP and two current generators CG1, CG2 arranged in current mirror and controlled by a voltage V_{Iref}. Here, the two capacitors Cref, Cas have the same value and the generators CG1, CG2 deliver the same current Iref. Sequential circuit WLCC delivers signals INIT1, RST1, INIT2, RST2, the clock signal inhibition CKEN described above, as well as the modulation signal Slm4 applied to the load modulator circuit LMC. Sequential circuit WLCC receives on an input IN1 the data DTx to be transmitted, read in memory MEM and sent by central processing unit UC. Sequential circuit WLCC also receives on an input IN2 the output signal OUTCMP of comparator CMP, and receives on an input IN3 the clock signal H delivered by the extraction circuit CC1. Capacitor Cref is connected to generator CG1 by means of switch T1, driven by signal INIT1. Switch T2 is arranged in parallel with capacitor Cref and is driven by signal RST1. Similarly, capacitor Cas is connected to generator CG2 by means of switch T3 which is driven by signal INIT2. Switch T4 is arranged in parallel with capacitor Cas and is driven by signal RST2. Lastly, the anodes of capacitors Cref, Cas, at voltages respectively equal to Vref, Vas, are applied to the inputs of comparator CMP.

Clock extraction circuit CEC1 conventionally comprises D latches arranged in cascade, for example five latches D1 to D5. The latches have their output/Q brought back to the input D and the output Q of each latch feeds the clock input CK of the following latch. The output Q of the last latch D5 delivers the clock signal H. The input CK of the first latch D1 receives the voltage Vac of frequency Fo, by means of an isolating capacitor Ci and an inverting gate INV1 used as an input buffer. Thus, the frequency F_{H} of clock H is here equal to the carrier frequency Fo divided by 16, that is 847 kHz for a carrier of 13,56 MHz.

According to the invention, gate INV1 is supplied with voltage Vcc by means of a PMOS transistor T5 driven by signal CKEN, and the output of gate INV1 is connected to ground by means of a NMOS transistor T6 driven by signal CKEN. Thus, when signal CKEN is at 1, extraction circuit CEC1 is inhibited and consumes no more current.

The operation of circuit CC1 is illustrated in FIGS. 6A to 6I, which respectively show the signals Slm4, CKEN, RST1, INIT1, Vref, RST, INIT2, Vas, OUTCMP. There can be seen synchronous operating periods, during which circuit CC1 is synchronized by clock signal H, and asynchronous operating periods, during which signal CKEN is at 1 and clock extraction circuit CEC1 is inhibited.

Synchronous Operating Periods

During these periods, signal RST2 is at 1 and capacitor Cas is maintained discharged. Sequential circuit WLCC receives a new bit of signal DTx and computes the moment when a pulse must be sent. In parallel, sequential circuit WLCC sets quickly signal RST1 to 1 for discharging capacitor Cref and sets then signal INIT1 to 1 during a time Tref. Time Tref is fixed by a predetermined number of clock H cycles and is here a quarter of the binary period Tb of signal DTx. Voltage Vref appearing at the terminals of capacitor Cref is thus determined by charge time Tref and current Iref.

Asynchronous Operating Periods

When signal Slm4 is set to 1, that is when a modulation pulse is sent, signal CKEN is set to 1, signal RST2 is set to 0 and signal INIT2 set to 1. Capacitor Cas charges during a time Tas until voltage Vas at its terminals reaches the value Vref and signal OUTCMP switches to 1. When signal OUTCMP switches to 1, signal Slm4 is reset to 0, which represents the end of the pulse.

The asynchronous operating periods may end at this moment and signal CKEN may be reset to 0. However, optionally, it is preferred to extend their duration so as to reduce even more the consumption of circuit IC1. Thus, as it can be seen in FIG. 6, capacitor Cas is discharged very quickly at the end of each pulse (RST2=1) for being immediately charged again (INIT2=1). Signal CKEN, FIG. 6B, is reset to 0 only at the end of the additional charge cycle, when signal OUTCMP switches to 1 for the second time. The duration of the asynchronous periods is thus here equal to 2Tas.

It follows from the foregoing that time Tas is equal to time Tref which is synchronously determined, capacitors Cref, Cas having a same value and being charged by means of an identical current Iref. Thus, the modulation pulses have a duration Tas which does not vary with time, temperature and the becoming old of the integrated circuit. The duration Tas may be defined as being “pseudo synchronous” and allows integrated circuit IC1 to remain synchronous with a data emitting-receiving station in spite of the cyclic suppression of clock signal H. It is clear that this aspect of the invention is likely to have various alternatives regarding the values of capacitors Cref, Cas and the charge currents, which could be different. Also, the duration Tas could be a multiple or a sub-multiple of Tref. What is important is that capacitor Cref is charged in a synchronous way, and the ratio between the charge current of capacitor Cref and the charge current of capacitor Cas remains constant when time elapses.

In the other hand, all the synchronous elements of integrated circuit IC1 being OFF during the asynchronous operating periods, it appears that the electric consumption of circuit IC1 is limited to charge current Iref and the current consumed by rectifier bridge Pd, that is a consumption practically equal to zero, of the order of a microampere. Thus, the invention efficiently solves the problem of contactless integrated circuits consumption during the load modulation periods. The communication distance with integrated circuit IC1 is brought to its maximal value, determined by the emitting power of the antenna coil of a data emitting-receiving station.

Example of Embodiment of Sequential Circuit WLCC

FIG. 7 shows an example of a simple embodiment of sequential circuit WLCC in the case where the binary period Tb of signal DTx comprises 16 cycles of clock H, that is a binary clock frequency Hb of about 52 kHz for a clock H frequency of 847 kHz. Sequential circuit WLCC is implemented by means of a conventional coding circuit MLP performing a pulsed Miller coding of signal DTx, the transformation of signal DTx into Manchester coded intermediate signal S1 being implicit. Conventionally, circuit MLP receives as inputs three bits bn, bn+1, bn+2 of signal DTx, stored in a shift register SHRG, and one bit being a new bit at each new cycle of the binary clock Hb. Still conventionally, circuit MLP receives as inputs signals Sq and Sh respectively indicating that the quarter of binary period Hb and the half of binary period Hb are reached. Bit Sq is here a bit b2 taken at the output of a four-bit counter CP1, driven by the clock signal H, comprising four output bits b0, b1, b2, b3. Bit Sh is bit b3.

In order to compensate the loss of the clock signal during the asynchronous periods, which represent here the half of the binary period Tb, that is 8 clock cycles, counter CP1 is arranged to start each new counting from an offset value equal to 8, after each reset on its input RST. For the same raison, the binary clock signal Hb of period Tb is delivered by a counter CP2 providing a clock signal Hb every 8 cycles of clock H, instead of 16 in the prior art.

The pulsed Miller output of circuit MLP is applied to input D of a latch D6 synchronized by clock signal H. Output Q of latch D6 is applied to input S of a latch SR1 and to reset input RST of counter CP1. Output Q of latch SR1 is applied to input D of a latch D7 and to an input of an OR-gate OR1 receiving, on its other input, output Q of latch D7. The output of gate OR1 is sent to an input of an AND-gate AD1 and to the inverted input of an OR-gate OR2. Gate AD1 receives also, on an inverted input, the output of gate OR2. The signal OUTCMP delivered by comparator CMP (FIG. 5) is respectively applied to an input of gate OR2, to clock input CK of latch D7, to input R of latch SR1 and to reset input RST of latch D6.

Signal Slm4 is taken at output Q of latch D6, clock inhibition signal CKEN is taken at the output of gate OR1, signal INIT2 is taken at the output of gate AD1 and signal RST2 is taken at the output of gate OR2.

Sending a Pulse

The start of a load modulation pulse is triggered by coder MLP and is synchronized with clock H by means of latch D6. When the pulse is emitted (Slm4=1), counter CP1 is brought back to the offset value and the Q outputs of latches D6 and SR1 switch to 1. Signals CKEN and INIT2 switch to 1 and signal RST2 switches to 0.

End of a Pulse

The end of a modulation pulse is triggered by the switching to 1 of signal OUTCMP, after a time Tas=Tref. Latch D6 is reset and signal RST2 is temporarily set to 1, until capacitor Cas is discharged.

Extension of the Asynchronous Period

At the end of a pulse, latch SR1 switches to 0 but output Q of latch D7 switches to 1, which allows signal CKEN to be maintained at 1. At the end of the second charge cycle of capacitor Cas, signal OUTCOMP switches to 1 for the second time and the output of latch D7 switches to 0, so that signal CKEN switches to 0. Clock signal H is emitted again and counter CP1 is reactivated.

Synchronous Period: Initialization of Cref

Sequential circuit WLCC comprises a counter CP3 driven by clock signal H, receiving signal CKEN on its reset input RST. After having been reset at the start of a synchronous period, counter CP3 sets its output to 1 once only, when some counting value, for example number “3”, is reached. The output of counter CP3 is applied to a logic monostable circuit MST and to a logic delay line DL. The monostable circuit delivers signal RST1 in the form of a pulse and delay line DL delivers signal INIT1 after pulse RST1.

Alternatives of the Invention

It will be clearly apparent to those skilled in the art that the present invention is likely to have various alternatives and improvements.

On one hand, the use of pulsed Miller coding has been given by way of a non limiting example only, as well as the Manchester coding of signal S1. In a general way, signal S1 may have any coded form comprising at least one variation edge at each binary period Tb. Also, this variation edge may be fixed at the quarter of period Tb, three quarters of period Tb, . . . instead of being fixed at the half-period Tb as described above.

On the other hand, it is within the skills of those skilled in the art to provide other alternative embodiments of the asynchronous time base system according to the invention by charges or discharges of capacitors.

Furthermore, an alternative embodiment consists in extending the duration of the asynchronous period by renewing the charge cycle of capacitor Cas as much as necessary. Indeed, it can be seen in FIG. 6B various synchronous operating periods Ts1, Ts2, Ts3 of unequal duration, which depend on the duration Ti between two pulses. The longer synchronous periods Ts2, Ts3 may thus be shortened and brought to the duration of the shortest synchronous period Ts1, by linking several charge cycles of capacitor Cas. In practice, the duration of the synchronous operating periods may thus be reduced to the minimum, that is to the time required by reading a bit in memory MEM, transmitting the bit to sequential circuit WLCC, and the time required by sequential circuit WLCC to compute the position of the next modulation pulse. For example, among the sixteen clock pulses H emitted here at each period Tb of the binary clock Hb, four or five only are generally sufficient for performing the above-mentioned reading, transmission and computation operations. The control of the asynchronous periods duration by the duration Ti between two pulses is obtained in a simple way by means of a sequential logic circuit using the value of the bits bn, bn+1, bn+2 present in shift register SHRG, computing the duration Ti between the emitted pulse and the next pulse, and determining the maximal number of charge cycles of capacitor Cas which can be performed before the next pulse.

Lastly, although the present invention generally aims at improving the ratio between the energy transmited by induction and the energy consumed by an integrated circuit, the techniques of load modulation by pulses and asynchronous determination of the duration of a pulse which have been described are suitable for contactless integrated circuits which, although operating synchronously with the data emitting-receiving station, comprise an own supply source. On the other hand, the invention allows a modulation depth representing 100% of the amplitude of the magnetic field to be provided and improves the signal/noise ratio at reception. The invention is also suitable for any type of clock extraction circuit, for example those using a coil different from the load modulation coil for receiving an a.c. induced voltage.

1. Contactless integrated circuit (IC1) comprising a device (LMC) for modulating the load of an antenna coil (Ls), a device (CEC1) for extracting a clock (H), and means for delivering a load modulation signal according to a binary signal to be transmitted (DTx), characterized in that it comprises means (CC1) for delivering a pulsed load modulation signal (Slm4) comprising a series of load modulation pulses (I1-In), the duration of which is asynchronously calibrated by the charge or the discharge of at least one capacitor (Cas).

2. Integrated circuit according to claim 1, characterized in that it comprises means (WLCC, INV1, T5, T6) for inhibiting the clock (H) extraction device (CEC1) at least during the emission of the load modulation pulses.

3. Integrated circuit according to one of the claims 1 and 2, wherein the means (CC1) for delivering the pulsed modulation signal (Slm4) comprise at least two capacitors (Cref, Cas) and means (WLCC, CG1, CMP, D6, SR1, T1, T2, T3, T4) for:
charging the first capacitor (Cref) with a constant current (Iref) before the emission of a load modulation pulse, during a time (Tref) fixed by a predetermined number of clock cycles (H),
charging the second capacitor (Cas) with a constant current (Iref) during the emission of a pulse, and
stopping the emission of the pulse when the charge voltage (Vas) of the second capacitor is equal to the voltage (Vref) at the terminals of the first capacitor.

4. Integrated circuit according to one of the claims 1 to 3, comprising means (WLCC) for:
transforming the binary signal to be transmitted (DTx) into a binary coded signal (S1) presenting at least, at each bit of the binary signal, a rising or falling variation edge, and
transforming variation edges of the binary coded signal (S1) into load modulation pulses (I1-In) of short duration compared to the duration (Tb) of a bit of the binary signal to be transmitted (DTx).

5. Integrated circuit according to claim 4, wherein variation edges of a same type only, rising or falling, of the binary coded signal (S1) are transformed into load modulation pulses by the means (CC1) for delivering the pulsed modulation signal.

6. Integrated circuit according to one of the claims 1 to 5, wherein the modulation signal (Slm4) is combined with an a.c. signal (Fsc) in order to form a load modulation signal comprising a.c. signal pulses.

7. Integrated circuit according to one of the claims 1 to 6, wherein the load modulation pulses have a duration (Tas) shorter than or equal to the quarter of the duration of a bit of the binary signal to be transmitted (DTx).

8. Integrated circuit according to one of the claims 1 to 7, wherein the clock extraction device (CEC1) is maintained in an inhibited state after the emission of a load modulation pulse, at least for a time (Tref, Tas) equal to the duration of a load modulation pulse.

9. Integrated circuit according to one of the claims 1 to 8, wherein the clock extraction device (CEC1) is arranged to extract a clock signal (H) from an a.c. voltage (Vac) induced in the antenna coil (Ls).

10. Integrated circuit according to one of the claims 1 to 9, characterized in that it comprises means (Pd, C2) for extracting a d.c. supply voltage (Vcc) from the a.c. voltage (Vac) induced in the antenna coil (Ls).

11. Integrated circuit according to one of the claims 1 to 10, wherein the means for inhibiting the clock extraction device (CEC1) comprise means (T5, T6) for powering-off the extraction device (CEC1).
